(19) United States
(12) Patent Application Publication
(10) Pub. No.: US 2007/0115688 A1
(43) Pub. Date: May 24, 2007

(54) Backlight module having matrix of light tubes and liquid crystal display having same

(75) Inventors: Kun-Hsien Yang, Miao-Li (TW); An Shih, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/603,507

(22) Filed: Nov. 22, 2006

(30) Foreign Application Priority Data
Nov. 23, 2005 (CN) 200510101763.6

(51) Int. Cl. F21V 8/00

(52) U.S. Cl. 362/614; 362/634

(57) ABSTRACT

An exemplary backlight module (12) includes a diffusing film (14), a frame (16), and a plurality of light tubes (18). The frame includes a bottom wall. The diffusing film is received in the frame. The light tubes are located between the diffusing film and the bottom wall of the frame. The light tubes are arranged in a matrix.

### FIELD OF THE INVENTION

The present invention relates to backlight modules such as those used in liquid crystal displays (LCDs); and more particularly to a backlight module having a matrix of light tubes, and a liquid crystal display including the backlight module.

### GENERAL BACKGROUND

Liquid crystal displays are commonly used as displays for compact electronic apparatuses, because they not only provide good quality images with little power but are also very thin. The liquid crystal in a liquid crystal display does not emit any light itself. The liquid crystal has to be lit by a light source so as to clearly and sharply display text and images. Thus, a backlight module is generally needed for a liquid crystal display.

There are generally two kinds of backlight modules, namely direct-type backlight modules and side-edge backlight modules. A large-sized liquid crystal display generally requires very high brightness, which is difficult for a side-edge backlight module to achieve. On the contrary, a direct-type backlight module can generally provide enough brightness for a large-sized liquid crystal display. Therefore, direct-type backlight modules are more popularly used in large-sized liquid crystal displays.

Light tubes are generally used as light sources for direct-type backlight modules. A popular kind of light tube is the cold cathode fluorescent lamp (CCFL). In a typical direct-type backlight module, a plurality of linear light tubes are horizontally arranged in parallel and cooperatively serve as a light source. A length of the light tubes corresponds to a size of the backlight module. That is, the larger the size of the backlight module, the greater the length of each light tube. Due to inherent limitations in the manufacturing of light tubes, it is difficult to manufacture light tubes that are very long. In another typical direct-type backlight module, a plurality of linear light tubes are vertically arranged in parallel and cooperatively serve as a light source. However, gaseous mercury in the light tubes is heavier than other constituents. The gaseous mercury is liable to drift down and concentrate in bottom end portions of the light tubes due to the effect of gravity. Thus, the uniformity of light eventually output by the backlight module is liable to be diminished.

What is needed, therefore, is a backlight module that can overcome the above-described deficiencies. What is also needed is a liquid crystal display employing such a backlight module.

### SUMMARY

In one preferred embodiment, a backlight module includes a diffusing film, a frame, and a plurality of light tubes. The frame includes a bottom wall. The diffusing film is received in the frame. The light tubes are located between the diffusing film and the bottom wall of the frame. The light tubes are arranged in a matrix.

Other aspects, advantages and novel features will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of the described embodiments. In the drawings, like reference numerals designate corresponding parts throughout various views, and all the views are schematic.

FIG. 1 is an exploded, side cross-sectional view of a liquid crystal display according to a first embodiment of the present invention, the liquid crystal display including a plurality of linear light tubes.

FIG. 2 is essentially a top plan view of the light tubes and an inverter of the liquid crystal display of the first embodiment, showing the light tubes arranged in a matrix having two columns and four rows and showing electrical connections therebetween.

FIG. 3 is similar to FIG. 2, but showing a corresponding view in the case of a liquid crystal display according to a second embodiment of the present invention.

### DETAILED DESCRIPTION OF PREFERRED EMBODIMENTS

Reference will now be made to the drawings to describe the preferred embodiments in detail.

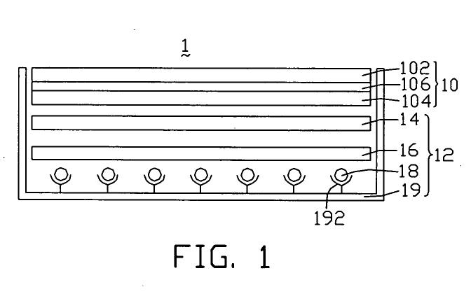

Referring to FIG. 1, a liquid crystal display 1 according to a first embodiment of the present invention is shown. The liquid crystal display 1 includes a liquid crystal panel 10, and a backlight module 12 located adjacent to the liquid crystal panel 10.

The liquid crystal panel 10 includes an upper substrate 102, a lower substrate 104, and a liquid crystal layer 106 sandwiched between the upper substrate 102 and the lower substrate 104. The upper substrate 102 and the lower substrate 104 are transparent, and are generally made from glass or quartz.

The backlight module 12 is a direct-type backlight module, and includes a brightness enhancement film (BEF) 14, a diffusing film 16, and a plurality of light tubes 18, arranged in that order from top to bottom. The BEF 14 is located adjacent to the lower substrate 104 of the liquid crystal panel 10. The backlight module 12 further includes a frame 19 receiving the BEF 14, the diffusing film 16, the light tubes 18, and the liquid crystal panel 10.

The frame 19 has a generally U-shaped cross-section, and includes a bottom wall (not labeled). The bottom wall is coated with reflective material for reflecting light beams emitted from the light tubes 18. A plurality of holders 192 inwardly extends from the bottom wall of the frame 19. The holders 192 are arranged in four parallel lines on the bottom wall, corresponding to an arrangement of two columns of the light tubes 18 (see below). Each of the holders 192 is configured for fittingly supporting and securely holding one of opposite end portions of a corresponding light tube 18. In the illustrated embodiment, each holder 192 includes a stem (not labeled) perpendicularly extending from the bottom wall, and an arc-shaped receptacle (not labeled) at a top of the stem. The receptacle is configured for fittingly supporting and securely holding the end portion the corresponding light tube 18.

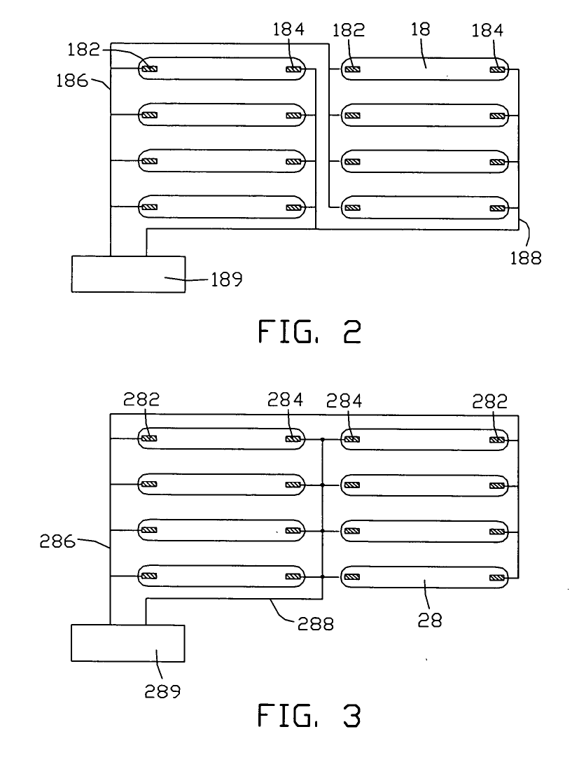

Referring also to FIG. 2, the plurality of light tubes 18 have substantially a same length and a same diameter, and are arranged in a matrix. In the illustrated embodiment, the light tubes 18 are substantially linear CCFLs, and the matrix has four rows and two columns. Each light tube 18 is horizontally arranged. The light tubes 18 in each column are arranged in parallel, with a substantially constant pitch between every two adjacent light tubes 18. All the light tubes 18 are electrically connected with each other in a parallel. Each light tube 18 includes a first electrode 182 and a second electrode 184. The first electrode 182 and the second electrode 184 are located at two opposite end portions (not labeled) of the light tube 18, respectively. In each row of the matrix, the second electrode 184 of the light tube 18 in the first column is physically adjacent to the first electrode 182 of the corresponding light tube 18 in the second column. A distance between the second electrodes 184 of the light tubes 18 in the first column and the first electrodes 182 of the light tubes 18 in the second column is substantially constant. The first electrodes 182 of the light tubes 18 in the matrix are electrically connected with a first metal conductive wire 186, which transmits a high voltage. The second electrodes 184 of the light tubes 18 in the matrix are electrically connected with a second metal conductive wire 188, which transmits a low voltage. The first metal conductive wire 186 and the second metal conductive wire 188 are each electrically connected with an inverter 189, which can convert a direct current (DC) voltage to an alternating current (AC) voltage.

The light tubes 18 are horizontally arranged, which can prevent gaseous mercury therein from concentrating in end portions thereof. Therefore the backlight module 12 using the light tubes 18 can achieve uniform optical performance. Further, the light tubes 18 are arranged in a matrix. That is, each row includes at least two light tubes 18. For a large-sized liquid crystal display 1, this can greatly reduce or eliminate the difficulty of otherwise having to manufacture particularly long light tubes. That is, the light tubes 18 need not be overly long, and are therefore relatively easy to manufacture. Thus the large-sized liquid crystal display 1 using the light tubes 18 can be readily manufactured.

Referring to FIG. 3, a liquid crystal display 2 according to a second embodiment of the present invention is similar to the liquid crystal display 1. The liquid crystal display 2 includes a plurality of light tubes 28 arranged in a matrix. In the illustrated embodiment, the matrix has four rows and two columns. The light tubes 28 are substantially linear CCFLs, and are electrically connected with each other in a parallel. Each light tube 28 includes a first electrode 282 and a second electrode 284. The first electrode 282 and the second electrode 284 are located at two opposite end portions (not labeled) of the light tube 28, respectively. In each row of the matrix, the second electrode 284 of the light tube 28 in the first column is physically adjacent to the second electrode 284 of the corresponding light tube 28 in the second column. The first electrodes 282 of the light tubes 28 are electrically connected with a first metal conductive wire 286, which transmits a low voltage. The second electrodes 284 of the light tubes 28 are electrically connected with a second metal conductive wire 288, which transmits a high voltage. The first metal conductive wire 286 and the second metal conductive wire 288 are each electrically connected with an inverter 289, which can convert a DC voltage to an AC voltage. The liquid crystal display 2 has advantages similar to those of the liquid crystal display 1.

Further or alternative embodiments may include the following. In one example, the matrix may have three, four, or more desired columns, and one, two, three, five or more desired rows. In another example, when the matrix of light tubes 18 has four rows and two columns, only three parallel lines of the holders 192 may be arranged on the bottom wall of the frame 19 (instead of four lines). In such case, each of the holders 192 in a central line of the holders 192 is configured for fittingly supporting and securely holding the end portions of two corresponding adjacent light tubes 18 in the matrix. In other examples, the holders 192 can have any of various other suitable configurations for securely holding the end portions of the light tubes 18. Further, the holders 192 at two sides of the matrix of light tubes 18 can extend from corresponding side walls (not labeled) of the frame 19 instead of from the bottom. wall of the frame 19. Moreover, at least portions of the side walls of the frame 19 can be coated with reflective material for reflecting light beams emitted from the light tubes 18, in addition to the bottom wall of the frame 19 being coated with reflective material.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A backlight module comprising:
a frame having a bottom wall;
a diffusing film received in the frame; and
a plurality of light tubes located between the diffusing film and the bottom wall of the frame, the light tubes being arranged in a matrix.

2. The backlight module in claim 1, wherein each of the light tubes is substantially linear.

3. The backlight module in claim 2, wherein the light tubes are cold cathode fluorescent lamps.

4. The backlight module in claim 2, wherein each light tube comprises a first electrode and a second electrode respectively located at two opposite end portions of the light tube.

5. The backlight module in claim 4, wherein the first electrodes of the light tubes are electrically connected with a conductive wire which transmits a high voltage.

6. The backlight module in claim 5, wherein the second electrodes of the light tubes are electrically connected with a conductive wire which transmits a low voltage.

7. The backlight module in claim 6, wherein for any two adjacent columns of light tubes in the matrix, the second electrodes of the light tubes in a first one of the adjacent columns are adjacent to the first electrodes of the light tubes in a second one of the adjacent columns, except for second electrodes that are located at an edge of the matrix.

8. The backlight module in claim 6, wherein for any two adjacent columns of light tubes in the matrix, the first electrodes of the light tubes in a first one of the adjacent columns are adjacent to the first electrodes of the light tubes in a second one of the adjacent columns, except for first electrodes that are located at an edge of the matrix.

9. The backlight module in claim 4, wherein the light tubes in each column are arranged in parallel, with a substantially constant pitch between every two adjacent light tubes in the column.

10. The backlight module in claim 9, wherein for any two adjacent columns of light tubes in the matrix, a distance between the electrodes of the light tubes in a first one of the adjacent columns that are adjacent a second one of the adjacent columns and the electrodes of the light tubes in the second adjacent column that are adjacent the first column is substantially constant.

11. The backlight module in claim 1, wherein the bottom wall of the frame is coated with reflective material.

12. The backlight module in claim 1, wherein the frame further comprises a plurality of holders inwardly extending from the bottom wall thereof.

13. The backlight module in claim 12, wherein each of the holders includes a receptacle fittingly supporting and securely holding a corresponding one of two opposite end portions of a respective one of the light tubes.

14. The backlight module in claim 1, wherein the light tubes are electrically connected with each other in a parallel.

15. The backlight module in claim 1, wherein the light tubes have substantially a same length and substantially a same diameter.

16. A liquid crystal display comprising:
a liquid crystal panel; and
a backlight module located adjacent the liquid crystal panel, the backlight module comprising:
a frame having a bottom wall;
a diffusing film received in the frame; and
a plurality of light tubes located between the diffusing film and the bottom wall of the frame, the light tubes being arranged in a matrix.

17. A backlight module comprising:
a frame having a bottom wall;
a diffusing film received in the frame; and
a plurality of light tubes located between the diffusing film and the bottom wall of the frame, the light tubes being arranged in two dimensions in a plane;
wherein
there are at least two light tubes along each of said dimensions.
